(19) United States
(12) Patent Application Publication
(10) Pub. No.: US 2017/0156190 A1
(43) Pub. Date: Jun. 1, 2017

(54) ILLUMINATION CONTROL METHOD AND APPARATUS FOR INTELLIGENT BACKPACK

(71) Applicants: Le Holdings(Beijing)Co., Ltd., Beijing (CN); LETV SPORTS CULTURE DEVELOP(BEIJING) CO., LTD., Beijing (CN)

(72) Inventor: Dalong LI, Beijing (CN)

(21) Appl. No.: 15/247,599

(22) Filed: Aug. 25, 2016

Related U.S. Application Data
(63) Continuation of application No. PCT/CN2016/082229, filed on May 16, 2016.

(30) Foreign Application Priority Data
Nov. 30, 2015 (CN) 201510860172.0

(51) Int. Cl. H05B 37/02; F21V 8/00; F21V 23/04

(52) U.S. Cl. CPC H05B 37/0218; F21V 23/0464; G02B 6/0005

(57) ABSTRACT

Embodiments of the invention provide an illumination control method and apparatus for an intelligent backpack, where the intelligent backpack can illuminate; and if there are insufficient light rays in the current environment, then it will be determined that an optic fiber is put into illumination so that a user will be safe even in the scenario where there are insufficient light rays in the environment. If there are sufficient light rays in the current environment, then the optic fiber will not be put into illumination, so that the illumination can be controlled simply and conveniently without any manual intervention with the illumination; and moreover since the optic fiber is characterized by being safe, energy-saving, environment-conserving, free of maintenance, water-proof, and serving for a long period of time, the optic fiber can be installed in the backpack for illumination to thereby improve the utility of the intelligent backpack.

### CROSS REFERENCE TO RELATED APPLICATIONS

This application is a continuation of International Application No. PCT/CN2016/082229, with an international filing date of filed May 16, 2016, which is based upon and claims priority to Chinese Patent Application No. 201510860172.0, filed on Nov. 30, 2015, the entire contents of all of which are incorporated herein by reference.

### TECHNICAL FIELD

The present invention relates to the field of wearable devices, and particularly to an illumination control method and apparatus for an intelligent backpack.

### BACKGROUND

A backpack is a luggage bag to which one or two shoulder strips are attached, and although both the structure and the material of the backpack which has evolved so far have been improved, a general structure thereof includes the shoulder strip(s) and the luggage bag. Since it is difficult for a person to permanently carry a weight only using his or her hands, the backpack tends to be a preferred tool to carry or transport the weight.

The backpack has been applied in various scenarios of our life, e.g., walking, mountain climbing, excursion, traveling, bicycling, and other outdoor activities, or daily shopping, going to school, etc., where the backpack in use shall be comfortable and light-weighted. If some weight is carried using the backpack, for example, for goods transportation, camping, marching, etc., then the backpack in use may be designed variously, for example, the backpack can be made of a more breathable material, a support frame can be added to the inside of the backpack, the weight can be transferred to the hip of its user, a filler can be added to the shoulder strips to thereby alleviate a pressure on the shoulders and the back of the user, a waist strip can be attached to the backpack, etc.

At present, the backpack applied to whichever application scenario is commonly used for the user to carry some article, and the function thereof is so single that it is impossible for the user to experience any convenience or safety.

### SUMMARY

Embodiments of the invention provide an illumination control method and apparatus for an intelligent backpack so as to address such a problem in the prior art that the function of the backpack is so unitary that it is impossible for the user to experience any convenience or safety.

Particular technical solutions according to the embodiments of the invention are as follows:

In an aspect, embodiments of the disclosure provides an illumination control method for an intelligent backpack, the method including:

obtaining an intensity of light rays in the current environment; and

controlling an optic fiber of the intelligent backpack to or not to emit light, according to the intensity of light rays in the current environment.

In another aspect, embodiments of the disclosure provides an illumination control apparatus for an intelligent backpack, the apparatus including:

at least one processor; and

a memory communicably connected with the at least one processor for storing instructions executable by the at least one processor, wherein execution of the instructions by the at least one processor causes the at least one processor to:

obtain an intensity of light rays in the current environment; and

control an optic fiber of the intelligent backpack to or not to emit light, according to the intensity of light rays in the current environment.

In a further aspect, embodiments of the disclosure provides an intelligent backpack, including an intelligent backpack body, and a processor, a light ray sensor, and an optic fiber located on the intelligent backpack body, wherein:

the light ray sensor is configured to obtain an intensity of light rays in the current environment; and

the processor is configured to control the optic fiber of the intelligent backpack to or not to emit light, according to the intensity of light rays in the current environment.

With the illumination control method and apparatus for an intelligent backpack according to the embodiments of the invention, the optic fiber is installed in the intelligent backpack, and the intelligent backpack detects in real time the intensity of light rays in the current environment, and controls the optic fiber in the intelligent backpack to or not to emit light, according to the intensity of light rays in the current environment. With the technical solutions according to the embodiments of the invention, the intelligent backpack can illuminate to thereby extend the functions of the traditional backpack; and if there are insufficient light rays in the current environment, then it will be determined that the optic fiber is put into illumination so that a user will be safe even in the scenario where there are insufficient light rays in the environment; and if there are sufficient light rays in the current environment, then the optic fiber will not be put into illumination, so that the illumination can be controlled simply and conveniently without any manual intervention with the illumination. Moreover since the optic fiber is characterized by being safe, energy-saving, environment-conserving, free of maintenance, water-proof, and serving for a long period of time, the optic fiber can be installed in the backpack for illumination to thereby improve the utility of the intelligent backpack. Also since the optic fiber is characterized by being easily bendable, the shape of the optic fiber arranged on the intelligent backpack can be preset at will to thereby improve the pleasing appearance of the intelligent backpack.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic architectural diagram of an illumination system according to some embodiments;

FIG. 2 is a flow chart of illumination control on an intelligent backpack according to some embodiments;

FIG. 3 is a flow chart of controlling an optic fiber to emit light according to some embodiments;

FIG. 4 is a flow chart of controlling an optic fiber not to emit light according to some embodiments;

FIG. 5a is a schematic structural diagram of a first illumination control apparatus on an intelligent backpack according to some embodiments;

FIG. 5b is a schematic structural diagram of a second illumination control apparatus on an intelligent backpack according to some embodiments;

FIG. 5c is a schematic structural diagram of a third illumination control apparatus on an intelligent backpack according to some embodiments;

FIG. 5d is a schematic structural diagram of a fourth illumination control apparatus on an intelligent backpack according to some embodiments;

FIG. 6 is a schematic structural diagram of an intelligent backpack according to some embodiments; and

FIG. 7 is a schematic structural diagram of another illumination control apparatus for an intelligent backpack according to some embodiments.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

The embodiments of the invention will be described below in further details.

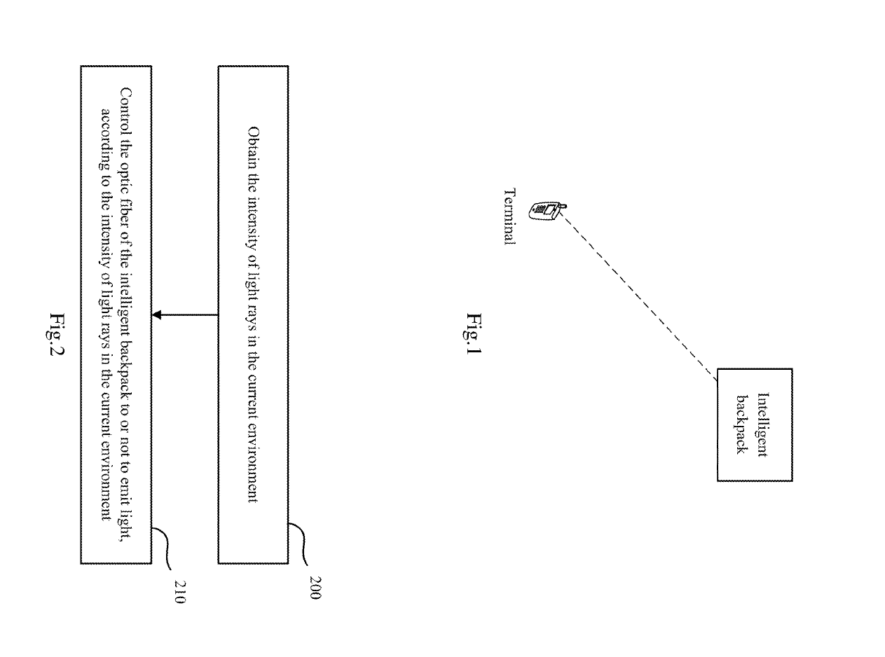

Referring to FIG. 1 illustrating a schematic architectural diagram of an illumination system according to an embodiment of the invention, the illumination system includes a terminal, and an intelligent backpack including an optic fiber, where the terminal is a device capable of communication, and the terminal includes a human-machine interaction interface; and the terminal includes an application for illumination control on the intelligent backpack, and the terminal can run the application for illumination control on the intelligent backpack, detect an operation by a user in a user interface of the application for illumination control on the intelligent backpack, and control the optic fiber on the intelligent backpack to be switched on or off, the color of light emitted by the optic fiber, a illumination mode of the optic fiber, and the illumination brightness of the optic fiber. The terminal can be a mobile phone, a tablet computer, etc.; and the intelligent backpack includes the optic fiber capable of emitting light, and the intelligent backpack capable of communication can response to a control instruction transmitted by the terminal.

### First Embodiment

Referring to FIG. 2, a process of illumination control on the intelligent backpack according to an embodiment of the invention includes the following operations:

The operation 200 is to obtain the intensity of light rays in the current environment.

In an embodiment of the invention, the terminal runs the application for illumination control on the intelligent backpack upon detection of a local input by the user to start the application for illumination control on the intelligent backpack, and presents the user interface of the application for illumination control on the intelligent backpack, on the terminal; the terminal transmits an instruction to open a light ray sensor to the intelligent backpack, upon detection of a selection by the user of an option to open the light ray sensor in the user interface; and the intelligent backpack controls the light ray sensor in the intelligent backpack to be opened, upon reception of the instruction to open the light ray sensor, and the light ray sensor obtains the intensity of light rays in the current environment in real time.

Furthermore the intelligent backpack can further include an illumination controller configured to control whether the illumination controller in the intelligent backpack is opened, where the illumination controller is configured to indicate whether the optic fiber can emit light or emit no light according to the intensity of light rays in the current environment. If it is not convenient for the user to control the terminal to transmit any instruction to the intelligent backpack, then the user can control directly the illumination controller on the intelligent backpack to control the light ray sensor on the intelligent backpack to be opened.

Particularly only when the illumination controller is opened, then the optic fiber can emit or not emit light according to the intensity of light rays in the current environment; and when the illumination controller is closed, then the optic fiber may remain its state before the illumination controller is closed, even if the intensity of light rays in the current environment satisfies such a condition that the optic fiber emits light or the optic fiber does not emit light. For example, if the optic fiber is emitting light, and the illumination controller is closed, then the optic fiber may keep emitting light even if the intensity of light rays in the current environment satisfies such a condition that the optic fiber does not emit light; and in another example, if the optic fiber is not emitting light, and the illumination controller is closed, then the optic fiber may be not emitting light even if the intensity of light rays in the current environment satisfies such a condition that the optic fiber emits light.

Optionally the illumination controller is controlled by a button connected with the illumination controller and located at a specified position on the intelligent backpack. Alternatively the intelligent backpack includes a control panel which can be located at a specified position on the intelligent backpack, or which can be located in a terminal paired with the intelligent backpack, where the terminal can be a mobile phone, a tablet computer, etc.; and the control panel includes a control interface of the illumination controller, and the user can set the illumination controller to be opened or closed in the control interface, for example, the control interface includes an option to open, and an option to close, the illumination controller, and if a selection by the user of the option to open the illumination controller in the control panel is detected, then the illumination controller may be controlled to be opened; and if a selection by the user of the option to close the illumination controller in the control panel is detected, then the illumination controller may be controlled to be closed.

With the technical solution according to the embodiment of the invention, the illumination controller or the instruction transmitted by the terminal can be controlled to control the optic fiber to or not to emit light according to the intensity of light rays in the current environment, thus avoiding the optic fiber from being started even if illumination by the optic fiber on the intelligent backpack is unnecessary for the user, so as to save power of the intelligent backpack; and moreover the illumination controller or the instruction transmitted by the terminal can be controlled to control the optic fiber to or not to emit light according to the intensity of light rays in the current environment, thus avoiding the optic fiber from being switched between light emission and no light emission if the intensity of light rays in the current environment frequently varies, so as to improve the utility of the intelligent backpack.

Optionally the intensity of light rays in the current environment is acquired by the light ray sensor in the intelligent backpack.

Optionally the light ray sensor is located on the outside of the intelligent backpack; and preferably the light ray sensor is located anywhere on the intelligent backpack other than the bottom thereof.

Optionally the intelligent backpack includes at least two light ray sensors located on different planes of the intelligent backpack.

Particularly the intelligent backpack can acquire intensities of light rays in the current environment concurrently using a plurality of light ray sensors, and if differences between the intensities of light rays in the current environment acquired by the respective light ray sensors lie in a preset range, then an average of the intensities of light rays in the current environment acquired by the respective light ray sensors may be obtained as the intensity of light rays in the current environment, where the average is an arithmetic average or a geometric average; and the preset range is an interval preset for a particular application scenario.

Optionally before the average of the intensities of light rays in the current environment acquired by the respective light ray sensors is obtained, abnormal one or more of the intensities of light rays acquired by the light ray sensors can be further eliminated. Particularly if the difference between the intensity of light rays in the current environment acquired by any one of the light ray sensors, and the intensity of light rays in the current environment acquired by each of the other light ray sensors lies out of the preset range, then the intensity of light rays in the current environment acquired by the any one of the light ray sensors may be determined as an abnormal intensity of light rays, where the preset range includes values preset for a particular application scenario.

With the technical solution above, the significantly deviating intensities of light rays in the current environment can be eliminated to avoid the optic fiber from emitting light or emitting no light improperly so as to improve the accuracy of illumination control on the optic fiber; and the intensities of light rays in the current environment can be acquired concurrently by the light ray sensors to thereby further guarantee the accuracy of illumination control on the optic fiber as compared with the intensity of light rays in the current environment acquired by a single light ray sensor.

The operation 210 is to control the optic fiber of the intelligent backpack to or not to emit light, according to the intensity of light rays in the current environment.

In an embodiment of the invention, if the intensity of light rays in the current environment reaches a preset intensity of light ray threshold, and the optic fiber is not emitting light, then the optic fiber of the intelligent backpack may be controlled to emit light; and if the intensity of light rays in the current environment does not reach the preset intensity of light ray threshold, and the optic fiber is emitting light, then the optic fiber of the intelligent backpack may be controlled not to emit light, where the preset intensity of light ray threshold is a value preset for a particular application scenario.

Furthermore the intelligent backpack can control illumination by the optic fiber by further controlling the illumination color of the optic fiber.

Optionally the intelligent backpack receives an instruction to control the illumination color of the optic fiber, where the instruction to control the illumination color of the optic fiber carries the illumination color; and the intelligent backpack includes a button to control the illumination color of the optic fiber, and the intelligent backpack determines an operation by the user to trigger the button to control the illumination color of the optic fiber as the instruction to control the illumination color of the optic fiber; or the intelligent backpack includes a control panel which can be located at a specified position on the intelligent backpack, or which can be located in a terminal paired with the intelligent backpack, where the terminal can be a mobile phone, a tablet computer, etc.; and the control panel includes an option to control the illumination color, and the user can set the option to control the illumination color, to thereby set the illumination color. For example, if a red selection by the user of the option to control the illumination color is detected, then the optic fiber may be controlled to emit red light rays.

Particularly the illumination color of the optic fiber can be controlled in the following three approaches:

In a first approach, since the illumination color of the optic fiber can be controlled by controlling the of illumination color of a light source, a plurality of light sources in different colors can be arranged in the intelligent backpack, where each of the light sources is provided with its identifier, and a first set of correspondence relationships is created in which there are correspondence relationships between the respective illumination colors and the respective light source identifiers; the light source identifier corresponding to the illumination color can be retrieved from the first set of correspondence relationships; and the light source identified by the light source identifier can be controlled to be switched on, and an optical signal emitted by the light source can be input to the optic fiber. For example, if the illumination color is the red color, and a light source identifier corresponding to the red color identifies a light source 1, then the light source 1 may be controlled to be switched on, and an optical signal emitted by the light source 1 may be input into the optic fiber.

Optionally if the illumination by the optic fiber is enabled by an optical signal of a light source, then the optic fiber of the intelligent backpack may be controlled to or not to emit light according to the intensity of light rays in the current environment particularly as follows: if the intensity of light rays in the current environment reaches a preset intensity of light ray threshold, and the optic fiber is not emitting light, then the light source may be controlled to be switched on, so that the optical signal emitted by the light source may be input into the optic fiber of the intelligent backpack to thereby enable the optic fiber to emit light; and if the intensity of light rays in the current environment does not reach the preset intensity of light ray threshold, and the optic fiber is emitting light, then the light source may be controlled to be switched off, so that the optic fiber of the intelligent backpack may not emit light.

In a second approach, since the illumination color of the optic fiber is dependent upon the material of the optic fiber, optic fibers made of a plurality of materials can be arranged in the intelligent backpack, and a second set of correspondence relationships can be created in which there are correspondence relationships between respective illumination colors and respective optic fiber identifiers; the optic fiber identifier corresponding to the illumination color can be retrieved from the second set of correspondence relationships; and an optical signal can be controlled to be input into the optic fiber identified by the optic fiber identifier. For example, if the illumination color is the red color, and an optic fiber identifier corresponding to the red color identifies an optic fiber 1, then the optic fiber 1 may be controlled to emit light.

In a third approach, since the illumination color of the optic fiber is dependent upon a wavelength corresponding to the illumination color, a power source and an optic-electric converter can be arranged in the intelligent backpack, and the optic-electric converter can emit optical signals at various wavelengths; and the intelligent backpack can determine the wavelength corresponding to the illumination color, control the power source to emit an electric signal, and control the optic-electric converter to convert the electric signal into an optical signal at a wavelength which is the wavelength corresponding to the illumination color, so that the optical signal is input into the optic fiber. With the technical solution above, optical signals at various wavelengths can be generated by the power source and the optic-electric converter without installing a plurality of light sources and a plurality of optic fibers in the intelligent backpack, to thereby reduce in effect the number of components in the intelligent backpack while enabling the optic fiber to emit light rays in more colors so as to improve the pleasing appearance and the utility of the intelligent backpack.

Further to the technical solution above, optionally a driving source of the optic fiber is a light source or a power source, and if the driving source is a power source, then an optic-electric converter may be arranged to convert an electric signal emitted by the power source into an optical signal.

With the technical solution above, the intelligent backpack can display a plurality of colors, so that the pleasing appearance of the intelligent backpack can be improved without affecting the illumination function of the intelligent backpack. And the user can control rapidly and conveniently the illumination color through the option to control the illumination color on the intelligent backpack or the terminal, so that the function of the intelligent backpack can be extended, and the utility of the intelligent backpack can be improved.

Optionally if the illumination by the optic fiber is enabled by an electric signal of a power source, then the optic fiber of the intelligent backpack may be controlled to or not to emit light according to the intensity of light rays in the current environment particularly as follows: if the intensity of light rays in the current environment reaches a preset intensity of light ray threshold, and the optic fiber is not emitting light, then the power source may be controlled to be switched on, so that an electric signal emitted by the power source may be input into the optic fiber of an optic-electric converter, and the optic-electric convert may convert the electric signal into the optical signal input into the optic fiber of the intelligent backpack to thereby enable the optic fiber to emit light; and if the intensity of light rays in the current environment does not reach the preset intensity of light ray threshold, and the optic fiber is not emitting light, then the power source may be controlled to be switched off, so that the optic fiber of the intelligent backpack may not emit light.

With the technical solution above, the color of light emitted by the optic fiber can be controlled rapidly and conveniently in a plurality of ways to thereby improve the flexibility of control on the optic fiber, and the pleasing appearance of the intelligent backpack.

Optionally since the optic fiber is characterized by being easily bendable in shape, the shape of the optic fiber arranged on the intelligent backpack can be further preset, for example, the optic fiber can be arranged heart-shaped, etc., to thereby improve the pleasing appearance of the intelligent backpack.

Optionally the intelligent backpack receives an instruction to control an illumination mode of the optic fiber, where the instruction to control an illumination mode of the optic fiber carries the illumination mode; and the intelligent backpack includes a button to control the illumination mode of the optic fiber, and the intelligent backpack determines an operation by the user to trigger the button to control the illumination mode of the optic fiber as the instruction to control the illumination mode of the optic fiber; or the intelligent backpack includes a control panel which can be located at a specified position on the intelligent backpack, or which can be located in a terminal paired with the intelligent backpack, where the terminal can be a mobile phone, a tablet computer, etc.; and the control panel includes an option to control the illumination mode, and the user can set the option to control the illumination mode, to thereby set the illumination mode. For example, if an always-illuminating selection by the user of the option to control the illumination mode is detected, then the illumination mode of the optic fiber may be controlled to be always illuminating; and if an flicking selection by the user of the option to control the illumination mode is detected, then the illumination mode of the optic fiber may be controlled to be flickering at a preset periodicity which can be a default periodicity preset in the application for illumination control on the intelligent backpack in the terminal, or which can be a user preset periodicity in the option to control the illumination mode.

With the technical solution above, the illumination mode of the optic fiber can be controlled rapidly and conveniently in a plurality of ways to thereby improve the flexibility of control on the optic fiber, and the pleasing appearance of the intelligent backpack.

Optionally the intelligent backpack receives an instruction to control the illumination brightness of the optic fiber, where the instruction to control the illumination brightness of the optic fiber carries the illumination brightness; and the intelligent backpack includes a button to control the illumination brightness of the optic fiber, and the intelligent backpack determines an operation by the user to trigger the button to control the illumination brightness of the optic fiber as the instruction to control the illumination brightness of the optic fiber; or the intelligent backpack includes a control panel which can be located at a specified position on the intelligent backpack, or which can be located in a terminal paired with the intelligent backpack, where the terminal can be a mobile phone, a tablet computer, etc.; and the control panel includes an option to control the illumination brightness, and the user can set the option to control the illumination brightness, to thereby set the illumination brightness. For example, the option to control the illumination brightness includes a number n of sub-options, each of sub-options corresponds to a brightness level, and if a brightness level 1 selection by the user of the option to control the illumination brightness is detected, then the optic fiber may be controlled to emit light rays at the highest brightness of light.

With the technical solution above, the intensity of light emitted by the optic fiber can be adjusted so that the intensity of light emitted by the optic fiber on the intelligent backpack can be adapted to various application scenarios to thereby improve the flexibility of control on the optic fiber.

With the technical solutions above, the illumination color, the illumination mode, the illumination intensity, etc., of the optic fiber on the intelligent backpack can be controlled via the user interface on the intelligent backpack; and optionally the user interface further includes an alert option, and if the intelligent backpack detects that the alert option is triggered, then the intelligent backpack may select the most strongly penetrating one of the illumination colors, and one of the illumination modes at the highest level of illumination intensity for the optic fiber to illuminate to thereby avoiding the user from being personally injured because he or she may not be observed by drivers of traveling vehicles, etc., so as to secure the user.

### Second Embodiment

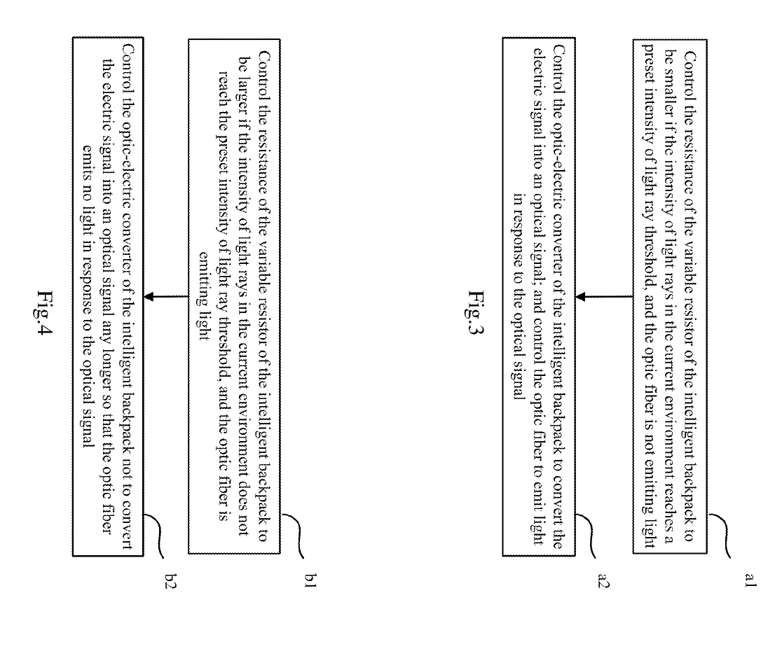

Further to the intelligent backpack according to the first embodiment, the intelligent backpack further includes a variable resistor, and referring to FIG. 3, if the illumination by the optic fiber is enabled by an electric signal of a power source, then the optic fiber of the intelligent backpack may be controlled to emit light particularly as follows:

The operation a1 is to control the resistance of the variable resistor of the intelligent backpack to be smaller if the intensity of light rays in the current environment reaches the preset intensity of light ray threshold, and the optic fiber is not emitting light.

In an embodiment of the invention, the intelligent backpack can adjust the size of current input to the optic-electric converter through the variable resistor, that is, if the resistance of the variable resistor is smaller, then the current transmitted by the power source of the intelligent backpack to the optic-electric converter may be controlled in size to be an electric signal reaching a preset current threshold, that is, the electric signal is sufficient to drive the optic-electric converter.

The operation a2 is to control the optic-electric converter of the intelligent backpack to convert the electric signal into an optical signal; and to control the optic fiber to emit light in response to the optical signal.

### Third Embodiment

Further to the intelligent backpack according to the first embodiment, the intelligent backpack further includes a variable resistor, and referring to FIG. 4, if the illumination by the optic fiber is enabled by an electric signal of a power source, then the optic fiber of the intelligent backpack may be controlled not to emit light particularly as follows:

The operation b1 is to control the resistance of the variable resistor of the intelligent backpack to be larger if the intensity of light rays in the current environment does not reach the preset intensity of light ray threshold, and the optic fiber is emitting light.

In an embodiment of the invention, the intelligent backpack can adjust the size of current input to the optic-electric converter through the variable resistor, that is, if the resistance of the variable resistor is larger, then the current transmitted by the power source of the intelligent backpack to the optic-electric converter may be controlled in size to be an electric signal which does not reach a preset current threshold, that is, the electric signal is insufficient to drive the optic-electric converter.

The operation b2 is to control the optic-electric converter of the intelligent backpack not to convert the electric signal into an optical signal any longer so that the optic fiber emits no light in response to the optical signal.

Furthermore in the technical solutions according to the first embodiment to the third embodiment, an option to start illumination is included in the user interface of the application for illumination control on the intelligent backpack, and if the terminal detects a selection by the user of the option to start illumination in the user interface, then the terminal may transmit an instruction to start the illumination by the optic fiber to the intelligent backpack; and upon reception of the instruction to start the illumination by the optic fiber, the intelligent backpack may start the illumination by the optic fiber directly without waiting for a result of detecting by the light ray sensor the intensity of light rays in the current environment.

### Fourth Embodiment

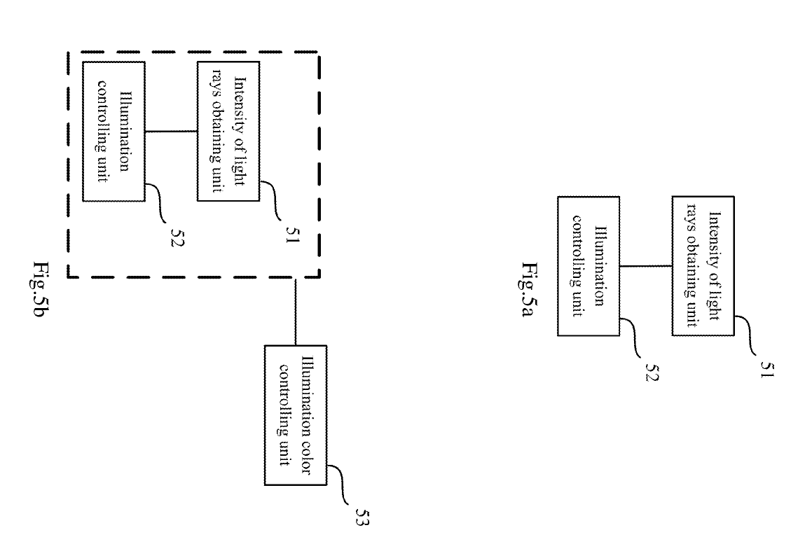

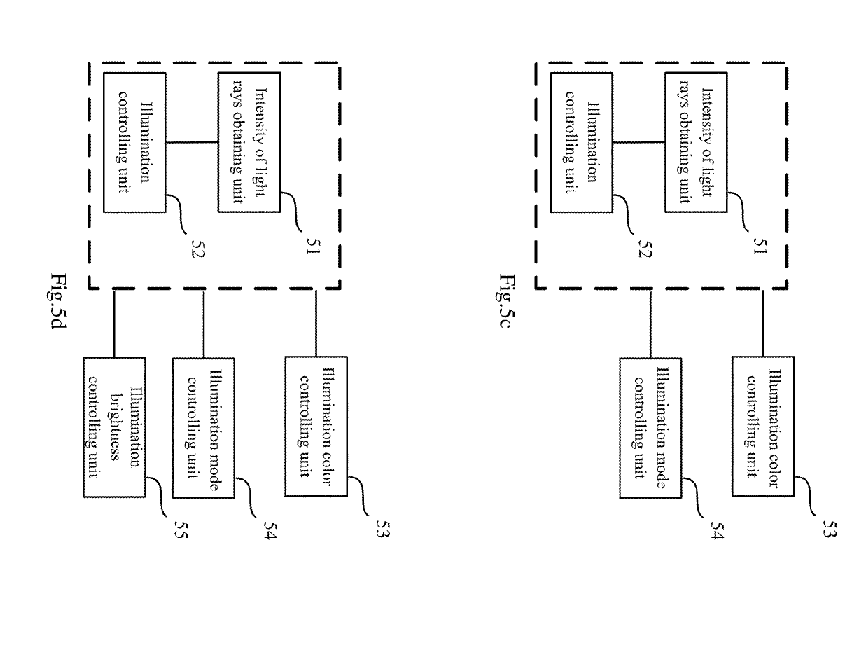

Further to the technical solutions according to the first embodiment to the third embodiment, referring to FIG. 5a, an embodiment of the invention further provides an illumination control apparatus for an intelligent backpack, where the apparatus includes an intensity of light rays obtaining unit 51 and an illumination controlling unit 52, where:

The intensity of light rays obtaining unit 51 is configured to obtain an intensity of light rays in the current environment; and

The illumination controlling unit 52 is configured to control an optic fiber of the intelligent backpack to or not to emit light, according to the intensity of light rays in the current environment.

Optionally the illumination controlling unit 52 is configured: to control the optic fiber of the intelligent backpack to emit light, if the intensity of light rays in the current environment reaches a preset intensity of light ray threshold, and the optic fiber is not emitting light; and to control the optic fiber of the intelligent backpack not to emit light, if the intensity of light rays in the current environment does not reach the preset intensity of light ray threshold, and the optic fiber is emitting light.

Optionally the illumination controlling unit 52 configured to control the optic fiber of the intelligent backpack to emit light, if the intensity of light rays in the current environment reaches a preset intensity of light ray threshold, and the optic fiber is not emitting light is configured: if the intensity of light rays in the current environment reaches the preset intensity of light ray threshold, and the optic fiber is not emitting light, to control the resistance of a variable resistor of the intelligent backpack to be smaller so that the size of current transmitted by a power source of the intelligent backpack to an optic-electric converter of the intelligent backpack is such that the current of an electric signal reaches a preset current threshold; to control the optic-electric converter of the intelligent backpack to convert the electric signal into an optical signal; and to control the optic fiber to emit light in response to the optical signal.

Referring to FIG. 5b, the apparatus further includes an illumination color controlling unit 53 configured to control an illumination color of the optic fiber of the intelligent backpack while controlling the optic fiber to be started.

Optionally the illumination color controlling unit 53 is configured: to receive an instruction to control the illumination color of the optic fiber, where the instruction to control the illumination color of the optic fiber includes the illumination color; to obtain a light source identifier corresponding to the illumination color; and to control a light source corresponding to the light source identifier to be switched on, and to input an optical signal emitted by the light source into the optic fiber; or to obtain a wavelength corresponding to the illumination color; to control a power source to emit an electric signal, and to control an optic-electric converter to convert the electric signal into an optical signal at a wavelength which is the wavelength corresponding to the illumination color; and to input the optical signal into the optic fiber; or to obtain an optic fiber identifier corresponding to the illumination color; and to control an optical signal to be input to an optic fiber identified by the optic fiber identifier.

Referring to FIG. 5c, the apparatus further includes an illumination mode controlling unit 54 configured to control an illumination mode of the optic fiber of the intelligent backpack while controlling the optic fiber to be started, where the illumination mode includes always-illuminating, or flickering at a preset periodicity.

Referring to FIG. 5d, the apparatus further include an illumination brightness controlling unit 55 configured to control an illumination brightness of the optic fiber of the intelligent backpack while controlling the optic fiber to be started.

### Fifth Embodiment

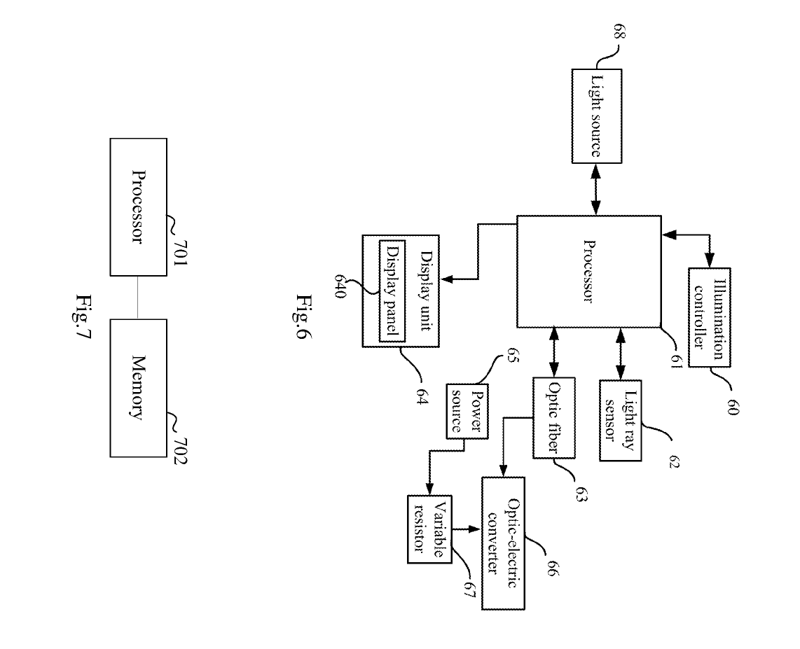

Further to the technical solutions according to the first embodiment to the third embodiment, referring to FIG. 6, an embodiment of the invention further provides an intelligent backpack including an intelligent backpack body, and a processor 61, a light ray sensor 62, and an optic fiber 63 located on the intelligent backpack body, where:

The light ray sensor 62 is configured to obtain an intensity of light rays in the current environment; and

The processor 61 is further configured to control the optic fiber 63 of the intelligent backpack to or not to emit light, according to the intensity of light rays in the current environment.

Furthermore the intelligent backpack further includes an illumination controller 60 configured to control the optic fiber 63 to indicate whether the optic fiber can emit light or emit no light according to the intensity of light rays in the current environment; the processor 61 is further configured to obtain the state of the illumination controller 60; and the light ray controller 62 is configured to obtain the intensity of light rays in the current environment if the state of the illumination controller at that time is opened.

Furthermore the intelligent backpack further includes a display unit 64 configured to present an option to control the state of the illumination controller 60, and an illumination color option. Furthermore the display unit 64 is further configured to display information input by a user, or information provided to the user, and various menus provided by the processor 61, where optionally the display unit 64 includes a display panel 640. Optionally the display panel 640 can be configured in the form of a Liquid Crystal Display (LCD), an Organic Light Emitting Diode (OLED) display, etc. Furthermore the display unit 64 above can further include a touch screen (not illustrated) which can overlie the display panel 640, where if the touch screen detects a touch operation thereon or proximate thereto, then the touch screen will transmit it to the processor 61, so that the processor 61 can determine the type of the touch event, and thereafter provide a corresponding visual output on the display panel 640 according to the type of the touch event. The touch screen and the display panel 640 can operate as two separate components to input and output information, but the touch screen and the display screen 640 can alternatively be integrated to input and output information, in some embodiments.

Furthermore the processor 61 is further configured to control the optic fiber 63 of the intelligent backpack to emit light, if the intensity of light rays in the current environment reaches a preset intensity of light ray threshold, and the optic fiber 63 is not emitting light; and to control the optic fiber 63 of the intelligent backpack not to emit light, if the intensity of light rays in the current environment does not reach the preset intensity of light ray threshold, and the optic fiber 63 is emitting light.

Furthermore the intelligent backpack further includes a power source 65 configured to power the respective components in the intelligent backpack.

Furthermore the intelligent backpack further includes an optic-electric converter 66 configured to convert an electric signal emitted by the power source 65 into an optical signal, and to transmit the optical signal into the optic fiber 63.

Furthermore the intelligent backpack further includes a variable resistor 67 located between the power source 65 and the optic-electric converter 66, and configured to control the size of current transmitted by the power source 65 to the optic-electric converter 66.

Furthermore the processor 61 is further configured, if the intensity of light rays in the current environment reaches the preset intensity of light ray threshold, and the optic fiber 63 is not emitting light, to control the resistance of the variable resistor of the intelligent backpack to be smaller so that the size of current transmitted by a power source of the intelligent backpack to an optic-electric converter of the intelligent backpack is such that the current of an electric signal reaches a preset current threshold; to control the optic-electric converter of the intelligent backpack to convert the electric signal into an optical signal; and to control the optic fiber to emit light in response to the optical signal.

Furthermore the intelligent backpack further includes a light source 68 connected with the optic fiber 63, and configured to provide the optic fiber 63 with an optical signal.

Optionally the processor 61 is further configured to receive an instruction to control an illumination color of the optic fiber, where the instruction to control the illumination color of the optic fiber includes the illumination color; to obtain a light source identifier corresponding to the illumination color; and to control a light source corresponding to the light source identifier to be switched on, and to input the optical signal emitted by the light source into the optic fiber; or to obtain a wavelength corresponding to the illumination color; to control the power source to emit an electric signal, and to control an optic-electric converter to convert the electric signal into an optical signal at a wavelength which is the wavelength corresponding to the illumination color; and to input the optical signal into the optic fiber; or to obtain an optic fiber identifier corresponding to the illumination color; and to control the optical signal to be input to an optic fiber identified by the optic fiber identifier.

Furthermore the processor 61 is further configured to control an illumination mode of the optic fiber of the intelligent backpack while controlling the optic fiber to be started, where the illumination mode includes always-illuminating, or flickering at a preset periodicity.

Furthermore the processor 61 is further configured to control an illumination brightness of the optic fiber of the intelligent backpack while controlling the optic fiber to be started.

In summary, in the embodiments of the invention, the intensity of light rays in the current environment is obtained; and the optic fiber of the intelligent backpack is controlled according to the intensity of light rays in the current environment to or not to emit light. With the technical solutions according to the embodiments of the invention, the intelligent backpack can illuminate to thereby extend the functions of the traditional backpack; and if there are insufficient light rays in the current environment, then it will be determined that the optic fiber is put into illumination so that the user will be safe even in the scenario where there are insufficient light rays in the environment. If there are sufficient light rays in the current environment, then the optic fiber will not be put into illumination, so that the illumination can be controlled simply and conveniently without any manual intervention with the illumination; and moreover since the optic fiber is characterized by being safe, energy-saving, environment-conserving, free of maintenance, water-proof, and serving for a long period of time, the optic fiber can be installed in the backpack for illumination to thereby improve the utility of the intelligent backpack. Also since the optic fiber is characterized by being easily bendable in shape, the shape of the optic fiber arranged on the intelligent backpack can be preset at will to thereby improve the pleasing appearance of the intelligent backpack.

Based upon the same inventive idea, an embodiment of the disclosure further provides an illumination control apparatus for an intelligent backpack, as illustrated in FIG. 7, which includes:

At least one processor 701 and a memory 702, where there is one processor as an example in FIG. 7.

The memory 702 is communicably connected with the at least one processor for storing instructions executable by the at least one processor, wherein execution of the instructions by the at least one processor causes the at least one processor to:

Obtain an intensity of light rays in the current environment; and

Control an optic fiber of the intelligent backpack to or not to emit light, according to the intensity of light rays in the current environment.

In one embodiment, the execution of the instructions by the at least one processor further causes the at least one processor to:

Control the optic fiber of the intelligent backpack to emit light, if the intensity of light rays in the current environment reaches a preset intensity of light ray threshold, and the optic fiber is not emitting light; and

Control the optic fiber of the intelligent backpack not to emit light, if the intensity of light rays in the current environment does not reach the preset intensity of light ray threshold, and the optic fiber is emitting light.

In one embodiment, the execution of the instructions by the at least one processor further causes the at least one processor to:

If the intensity of light rays in the current environment reaches the preset intensity of light ray threshold, and the optic fiber is not emitting light, control the size of current transmitted by a power source of the intelligent backpack to an optic-electric converter of the intelligent backpack so that the current of an electric signal reaches a preset current threshold;

Control the optic-electric converter of the intelligent backpack to convert the electric signal into an optical signal; and

Control the optic fiber to emit light in response to the optical signal.

In one embodiment, the execution of the instructions by the at least one processor further causes the at least one processor to:

Control an illumination color of the optic fiber of the intelligent backpack while controlling the optic fiber to be started.

In one embodiment, the execution of the instructions by the at least one processor further causes the at least one processor to:

Receive an instruction to control the illumination color of the optic fiber, wherein the instruction to control the illumination color of the optic fiber comprises the illumination color;

Obtain a light source identifier corresponding to the illumination color; and control a light source corresponding to the light source identifier to be switched on, and input an optical signal emitted by the light source into the optic fiber; or

Obtain a wavelength corresponding to the illumination color; control a power source to emit an electric signal, and control an optic-electric converter to convert the electric signal into an optical signal at a wavelength which is the wavelength corresponding to the illumination color; and to input the optical signal into the optic fiber; or

Obtain an optic fiber identifier corresponding to the illumination color; and control an optical signal to be input to an optic fiber identified by the optic fiber identifier.

In one embodiment, the execution of the instructions by the at least one processor further causes the at least one processor to:

Control an illumination mode of the optic fiber of the intelligent backpack while controlling the optic fiber to be started, wherein the illumination mode comprises always-illuminating, or flickering at a preset periodicity.

In one embodiment, the execution of the instructions by the at least one processor further causes the at least one processor to:

Control an illumination brightness of the optic fiber of the intelligent backpack while controlling the optic fiber to be started.

The embodiments of the apparatus described above are merely exemplary, where the units described as separate components may or may not be physically separate, and the components illustrated as elements may or may not be physical units, that is, they can be collocated or can be distributed onto a plurality of network elements. A part or all of the modules can be selected as needed in reality for the purpose of the solution according to the embodiments of the invention. This can be understood and practiced by those ordinarily skilled in the art without any inventive effort.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. An illumination control method for an intelligent backpack, the method comprising:
obtaining an intensity of light rays in the current environment; and
controlling an optic fiber of the intelligent backpack to or not to emit light, according to the intensity of light rays in the current environment.

2. The method according to claim 1, wherein obtaining the intensity of light rays in the current environment comprises:
obtaining, by a light ray sensor, the intensity of light rays in the current environment.

3. The method according to claim 2, wherein before the intensity of light rays in the current environment is obtained, the method further comprises:
receiving an instruction transmitted by a terminal to open the light ray sensor.

4. The method according to claim 1, wherein controlling the optic fiber of the intelligent backpack to or not to emit light, according to the intensity of light rays in the current environment comprises:
if the intensity of light rays in the current environment reaches a preset intensity of light ray threshold, and the optic fiber is not emitting light, then controlling the optic fiber of the intelligent backpack to emit light; and
if the intensity of light rays in the current environment does not reach the preset intensity of light ray threshold, and the optic fiber is emitting light, then controlling the optic fiber of the intelligent backpack not to emit light.

5. The method according to claim 4, wherein if the intensity of light rays in the current environment reaches the preset intensity of light ray threshold, and the optic fiber is not emitting light, then controlling the optic fiber of the intelligent backpack to emit light comprises:
if the intensity of light rays in the current environment reaches the preset intensity of light ray threshold, and the optic fiber is not emitting light, then controlling the size of current transmitted by a power source of the intelligent backpack to an optic-electric converter of the intelligent backpack so that the current of an electric signal reaches a preset current threshold;
controlling the optic-electric converter of the intelligent backpack to convert the electric signal into an optical signal; and
controlling the optic fiber to emit light in response to the optical signal.

6. The method according to claim 1, wherein while the optic fiber of the intelligent backpack is controlled to be started, the method further comprises:
controlling an illumination color of the optic fiber.

7. The method according to claim 6, wherein controlling the illumination color of the optic fiber comprises:
receiving an instruction to control the illumination color of the optic fiber, wherein the instruction to control the illumination color of the optic fiber comprises the illumination color;
obtaining a light source identifier corresponding to the illumination color; and controlling a light source corresponding to the light source identifier to be switched on, and inputting an optical signal emitted by the light source into the optic fiber; or
obtaining a wavelength corresponding to the illumination color; controlling a power source to emit an electric signal, and controlling an optic-electric converter to convert the electric signal into an optical signal at a wavelength which is the wavelength corresponding to the illumination color; and inputting the optical signal into the optic fiber; or
obtaining an optic fiber identifier corresponding to the illumination color; and controlling an optical signal to be input to an optic fiber identified by the optic fiber identifier.

8. The method according to claim 5, wherein while the optic fiber of the intelligent backpack is controlled to be started, the method further comprises:
controlling an illumination mode of the optic fiber, wherein the illumination mode comprises always-illuminating, or flickering at a preset periodicity.

9. The method according to claim 5, wherein while the optic fiber of the intelligent backpack is controlled to be started, the method further comprises:
controlling an illumination brightness of the optic fiber.

10. An illumination control apparatus for an intelligent backpack, the apparatus comprising:
at least one processor; and
a memory communicably connected with the at least one processor for storing instructions executable by the at least one processor, wherein execution of the instructions by the at least one processor causes the at least one processor to:
obtain an intensity of light rays in the current environment; and
control an optic fiber of the intelligent backpack to or not to emit light, according to the intensity of light rays in the current environment.

11. The apparatus according to claim 10, wherein the execution of the instructions by the at least one processor further causes the at least one processor to:
control the optic fiber of the intelligent backpack to emit light, if the intensity of light rays in the current environment reaches a preset intensity of light ray threshold, and the optic fiber is not emitting light; and
control the optic fiber of the intelligent backpack not to emit light, if the intensity of light rays in the current environment does not reach the preset intensity of light ray threshold, and the optic fiber is emitting light.

12. The apparatus according to claim 11, wherein the execution of the instructions by the at least one processor further causes the at least one processor to:
if the intensity of light rays in the current environment reaches the preset intensity of light ray threshold, and the optic fiber is not emitting light, control the size of current transmitted by a power source of the intelligent backpack to an optic-electric converter of the intelligent backpack so that the current of an electric signal reaches a preset current threshold;
control the optic-electric converter of the intelligent backpack to convert the electric signal into an optical signal; and
control the optic fiber to emit light in response to the optical signal.

13. The apparatus according to claim 10, wherein the execution of the instructions by the at least one processor further causes the at least one processor to:
control an illumination color of the optic fiber of the intelligent backpack while controlling the optic fiber to be started.

14. The apparatus according to claim 13, wherein the execution of the instructions by the at least one processor further causes the at least one processor to:
receive an instruction to control the illumination color of the optic fiber, wherein the instruction to control the illumination color of the optic fiber comprises the illumination color;
obtain a light source identifier corresponding to the illumination color; and control a light source corresponding to the light source identifier to be switched on, and input an optical signal emitted by the light source into the optic fiber; or
obtain a wavelength corresponding to the illumination color; control a power source to emit an electric signal, and control an optic-electric converter to convert the electric signal into an optical signal at a wavelength which is the wavelength corresponding to the illumination color; and to input the optical signal into the optic fiber; or
obtain an optic fiber identifier corresponding to the illumination color; and control an optical signal to be input to an optic fiber identified by the optic fiber identifier.

15. The apparatus according to claim 13, wherein the execution of the instructions by the at least one processor further causes the at least one processor to:
control an illumination mode of the optic fiber of the intelligent backpack while controlling the optic fiber to be started, wherein the illumination mode comprises always-illuminating, or flickering at a preset periodicity.

16. The apparatus according to claim 13, wherein the execution of the instructions by the at least one processor further causes the at least one processor to:
control an illumination brightness of the optic fiber of the intelligent backpack while controlling the optic fiber to be started.

17. An intelligent backpack, comprising an intelligent backpack body, and a processor, a light ray sensor, and an optic fiber located on the intelligent backpack body, wherein:
the light ray sensor is configured to obtain an intensity of light rays in the current environment; and
the processor is configured to control the optic fiber of the intelligent backpack to or not to emit light, according to the intensity of light rays in the current environment.
